(19) United States
(12) Patent Application Publication
(10) Pub. No.: US 2024/0298642 A1
(43) Pub. Date: Sep. 12, 2024

(54) Herbicidal Compositions Comprising Fluazifop And Triclopyr

(71) Applicant: Bayer CropScience LP, Saint Louis, MO (US)

(72) Inventors: Paul Glen RATLIFF, Saint Louis, MO (US); Ryan Kenneth TOTTEN, Saint Louis, MO (US); Gary Kenneth WINDLER, JR., Saint Louis, MO (US); Joseph Herman BRENNER, Saint Louis, MO (US)

(21) Appl. No.: 18/597,044

(22) Filed: Mar. 6, 2024

Related U.S. Application Data
(60) Provisional application No. 63/450,423, filed on Mar. 7, 2023.

(51) Int. Cl. A01N 43/40; A01N 25/02; A01N 25/30; A01N 43/60; A01P 13/00

(52) U.S. Cl. CPC A01N 43/40; A01N 25/02; A01N 25/30; A01N 43/60; A01P 13/00

(57) ABSTRACT

The present invention primarily relates to certain herbicidal compositions based on the herbicidal active ingredients (A) fluazifop or an ester thereof and (B) triclopyr or an ester or salt thereof, optionally additionally comprising (C) a diquat dihalide salt. The invention also relates to the field of plant protection and environmental health, and to methods and uses of the herbicidal compositions of the present invention for controlling unwanted plant growth.

### CROSS-REFERENCE TO RELATED APPLICATIONS

This application claims the benefit of and priority to U.S. Provisional Application No. 63/450,423, filed Mar. 7, 2023, the entire disclosure of which is hereby incorporated by reference.

### FIELD OF THE INVENTION

The present invention primarily relates to certain herbicidal compositions based on the herbicidal active ingredients (A) fluazifop or an ester thereof and (B) triclopyr or an ester or salt thereof, optionally additionally comprising (C) a diquat dihalide salt. The invention also relates to the field of plant protection and environmental health, and to methods and uses of the herbicidal compositions of the present invention for controlling unwanted plant growth.

### BACKGROUND OF THE INVENTION

The field of plant protection and environmental health amongst other aspects relates to controlling unwanted plants (weed plants, weeds) in urban or home environments like driveways, patios, sidewalks, paths, gravel areas, around trees and along fences.

Controlling unwanted plants (weed control) is generally desired in the field of environmental health, not only for aesthetic purposes, for example in landscape or hardscape areas, areas for parks, public or private gardens, sports grounds or arenas, flower gardens, mulch beds, ornamental gardens, around trees (e.g. plantations and orchards). In the management for instance in a garden, in public areas, roadsides, homes etc., control of weeds is the most important task for keeping views and good maintenance of the sites.

Up to now, however, typical satisfactory herbicide products for such weed control are based on glyphosate or dicamba.

Some commercial products like Roundup® products are based on the herbicidal active ingredient glyphosate in combination with other herbicidal active ingredients like pelargonic acid or in combination with imazapic ammonium and diquat dibromide (in case of the Roundup® 365-series). Other commercial products contain as herbicidal active ingredients ammonium nonanoate (e.g. Ortho™ Groundclear) or a combination of fluazifop-P-butyl, dicamba dimethyl ammonium, and diquat dibromide (e.g. Spectracide™ Weed&Grass Killer, Ortho™ Groundclear Weed&Grass Killer Super Concentrate).

Several publications disclose herbicidal combinations involving the above-mentioned herbicidal active ingredients (herbicides), often in combination with other herbicides. For example, WO 2004/093546 discloses herbicidal compositions comprising glyphosate and a pyridine analog, such as triclopyr, and WO 2006/033988 discloses compositions comprising glyphosate and fatty acid components like pelargonic acid, optionally comprising further herbicides.

Other publications like WO 2010/009819 or WO 2010/127796 suggest the use of compositions based on certain compounds, optionally in combination with other herbicides, for the selective weed (unwanted plant growth) control in turfgrass areas.

One objective of the present invention is to provide further herbicidal compositions which permit effective control of unwanted plants (weeds), and which particular permit effective control of unwanted plants (weeds) in the field of plant protection and environmental health, in particular without the necessity to use or presence of glyphosate (N-(phosphonomethyl)glycine), dicamba (3,6-dichloro-2-methoxybenzoic acid) or 2,4-D (2,4-dichlorophenoxy)acetic acid), or salts or esters thereof in said herbicidal compositions.

A further objective of the present invention is to provide such herbicidal compositions in a physically and/or chemically stable form.

### BRIEF DESCRIPTION OF THE INVENTION

The above objectives have been achieved with herbicidal compositions, wherein the herbicidal active ingredients comprise or consist of
(A) fluazifop or an ester thereof,
and
(B) triclopyr or an ester or an agriculturally acceptable salt thereof,
wherein the total amount of component (B) is at least about 4.5 wt. %, based on the total weight of the composition,
and/or
wherein the sum of the total amounts of Component (A) and Component (B) is at least about 8.0 wt. %, based on the total weight of the composition.

The above objects have also been achieved with herbicidal compositions, additionally comprising the herbicidal active ingredient (C) a diquat dihalide salt.

The herbicidal compositions of the present invention typically are concentrates, i.e. concentrated formulations which typically are diluted with an appropriate amount of water to form a ready-to-use (RTU) application mixture, before being applied to the undesired plants (weeds).

In some embodiments of herbicidal compositions of the present invention, the comparatively high amount of component (A) therein, the low water-solubility of fluazifop-esters, such as fluazifop-P-butyl, and/or the comparatively high ionic strength, resulted in challenges to produce a physically and/or chemically stable formulation. These challenges were in certain embodiments of the present invention overcome by including certain (types of) surfactants, certain (types of) organic solvents and/or mixtures of certain (types of) organic solvents. In some embodiments, the herbicidal compositions of the present invention are microemulsions, i.e. have a microemulsion structure that provides high physical stability, even in high ionic strength medium, and additionally, these herbicidal compositions of the present invention are in—can physically and chemically stable.

In further aspects, the present invention relates to methods for controlling weed plants using the compositions of the present invention in the form of a ready-to-use spray application mixture.

### DETAILED DESCRIPTION OF THE INVENTION

It has now been found that certain compositions comprising the herbicidal active ingredients fluazifop or an ester thereof (component (A)), and triclopyr or an ester or an agriculturally acceptable salt thereof (component (B)), and optionally additionally a diquat dihalide salt (component (C)), have the desired properties and provide the desired weed killing effects against a broad weed spectrum, and optionally early visual symptomology, i.e. early herbicidal or phytotoxic activity after application of the compositions.

Thus, in certain preferred embodiments, the herbicidal active ingredients of the herbicidal composition according to the present invention comprise or consist of
(A) fluazifop or an ester thereof,
(B) triclopyr or an ester or an agriculturally acceptable salt thereof,
and
(C) a diquat dihalide salt,
wherein the total amount of component (B) is at least about 4.5 wt. %, based on the total weight of the composition,
and/or
wherein the sum of the total amounts of Component (A) and Component (B) is at least about 8.0 wt. %, based on the total weight of the composition.

The active ingredient fluazifop (CAS Reg. No. 69335-91-7; IUPAC name: 2-[4-[[5-(trifluoromethyl)-2-pyridyl]oxy]phenoxy]propanoic acid) is a herbicidal ingredient (herbicide) known from WO 79/00094, the (+)-enantiomer of this substance has the common name fluazifop-P (CAS Reg. No. 83066-88-0). Fluazifop is an acetyl CoA carboxylase (ACCase) inhibitor. An important ester of fluazifop is fluazifop-butyl (CAS Reg. No. 69806-50-4), the (R)-enantiomer thereof is fluazifop-P-butyl (CAS Reg. No. 79241-46-6; IUPAC name: butyl (2R)-2-(4-{[5-(trifluoromethyl)pyridin-2-yl]oxy}phenoxy)propanoate)). Fluazifop and fluazifop-P-butyl are herbicides effective against grasses (monocotyledonous weeds).

The active ingredient triclopyr (CAS Reg. No. 55335-06-3; IUPAC name: [(3,5,6-trichloro-2-pyridyl)oxy]acetic acid) is a herbicidal ingredient (herbicide) known from U.S. Pat. No. 3,862,952. It is used in the agrochemical industry often as salt or ester, for example as triclopyr-triethylammonium (CAS Reg. No. 57213-69-1; IUPAC name: [(3,5,6-trichloro-2-pyridyl)oxy]acetic acid-triethylamine (1:1). Triclopyr is a synthetic auxin. Triclopyr is a systemic herbicide effective against broad-leaved (dicotyledonous) weeds.

The active ingredient diquat (CAS Reg. No. 2764-72-9; IUPAC name: 6,7-dihydrodipyrido[1,2-a:2′,1′-c]pyrazine-5,8-diium) is a herbicidal ingredient (herbicide) known from U.S. Pat. No. 2,823,987. It is used in the agrochemical industry often as salt, for example as diquat dibromide (CAS Reg. No. 85-00-7; IUPAC name: 6,7-dihydrodipyrido[1,2-a:2′,1′-c]pyrazine-5,8-diium dibromide). Diquat is an inhibitor of the Photosystem I. Diquat is used for non-selective weed control having no residual activity. In the context of the present invention, diquat is optionally used as co-herbicide providing early symptomology, i.e. early herbicidal or phytotoxic activity, against the undesired or unwanted plants (weeds).

In summary, in herbicidal compositions according to the present invention components (A) and (B) in combination largely account for the activity against grasses (component (A)) and broad-leaved (dicotyledonous) weeds (component (B)). Component (C), if present, provides for early symptomology, i.e. establishing fast and early phytotoxic or herbicidal activity. The compositions according to the present invention thus provide the combination of herbicidal activity against a broad weed spectrum (and with a fast onset of herbicidal symptomology, if component (C) is present).

In certain other preferred embodiments, in the herbicidal composition according to the present invention Component (A) comprises or consists of a fluazifop alkyl ester, typically fluazifop-P-butyl, and/or Component (B) comprises or consists of a triclopyr ammonium salt, typically triclopyr-triethylammonium.

In still other preferred embodiments, in the herbicidal composition according to the present invention Component (A) comprises or consists of fluazifop-P-butyl, Component (B) comprises or consists of triclopyr-triethylammonium, and Component (C), if present, comprises or consists of diquat dibromide.

The weight ratios of components (A) and (B), and optionally (C), can be varied within the ranges indicated herein. However, within certain concentration ranges or ratio by weight ranges, the herbicidal effects of the herbicidal compositions of the invention are particularly pronounced and/or the herbicidal activity and efficacy particularly high.

The herbicidal composition according to the present invention generally is a concentrated formulation (concentrate), i.e. a premix having a total high load of the herbicidal active ingredients (A) and (B), and optionally (C).

The herbicidal composition according to the present invention generally is a composition (i.e. a mixture) in the form of an oil-in-water concentrate, typically in the form of an oil-in-water emulsion, preferably in the form of an oil-in-water microemulsion. According to the IUPAC definition, a microemulsion (or micro-emulsion) is a dispersion made of water, oil, and surfactant(s) that is an isotropic and thermodynamically stable system with dispersed domain diameter varying approximately from 1 to 100 nm, usually 10 to 50 nm. As known in the art, depending on the relative proportion of water phase and oil phase contained therein, the microstructure of microemulsions can be oil-continuous or water-continuous or bi-continuous.

Generally, the herbicidal compositions according to the present invention showed very good to excellent physical stability. Generally, the herbicidal compositions according to the present invention were storage stable for at least 2 weeks, typically for at least 4 weeks at different temperatures when stored at −20° C., 0° C., 25° C., 40° C. and 54° C., respectively. The herbicidal compositions according to the present invention are very stable and exceed the typical standards.

In the herbicidal compositions according to the present invention, typically the sum of the total amounts of Component (A) and Component (B) is in the range of from about 8.0 wt. % to about 12.0 wt. %, based on the total weight of the composition.

In the herbicidal compositions according to the present invention, typically the sum of the total amounts of Component (A) and Component (B) is in the range of from about 8.5 wt. % to about 10.0 wt. %, based on the total weight of the composition.

In the herbicidal compositions according to the present invention, preferably Component (C) is present.

In the herbicidal compositions according to the present invention, typically the sum of the total amounts of Component (A), Component (B) and Component (C) is in the range of from about 9.0 wt. % to about 15.0 wt. %, based on the total weight of the composition.

In the herbicidal compositions according to the present invention, typically the sum of the total amounts of Component (A), Component (B) and Component (C) is in the range of from about 9.5 wt. % to about 13.0 wt. %, based on the total weight of the composition.

In certain preferred herbicidal compositions according to the present invention the ratio by weight of the total amount of component (A) to the total amount of component (B) is in the range of from about 3:2 to about 2:5, typically in the range of from about 1:1 to about 1:2, in each case based on the total weight of the composition. In some embodiments, the ratio by weight of the total amount of component (A) to the total amount of component (B) is in the range of from about 4:5 to about 3:5, based on the total weight of the composition.

In certain preferred herbicidal compositions according to the present invention the ratio by weight of the total amount of component (B) to the total amount of component (C) is in the range of from about 5:1 to about 3:2, typically in the range of from about 10:3 to about 5:3, in each case based on the total weight of the composition. In some embodiments, the ratio by weight of the total amount of component (B) to the total amount of component (C) is about 10:3, based on the total weight of the composition.

The herbicidal compositions according to the present invention typically comprise component (A) in a total amount in the range of from about 3.0 wt. % to about 4.5 wt. %, based on the total weight of the composition.

The herbicidal compositions according to the present invention typically comprise component (B) in a total amount in the range of from about 4.5 wt. % to about 6.0 wt. %, based on the total weight of the composition.

The herbicidal compositions according to the present invention typically comprise component (C), if present, in a total amount in the range of from about 1.0 wt. % to about 3.5 wt. %, preferably in a total amount in the range of from about 1.5 wt. % to about 3.0 wt. %, in each case based on the total weight of the composition.

The herbicidal compositions according to the present invention typically comprise the components (A) and (B) in the following amounts:
Component (A) in an amount in the range of from about 3.0 wt. % to about 4.5 wt. %, and
Component (B) in an amount in the range of from about 4.5 wt. % to about 6.0 wt. %,
in each case based on the total weight of the composition.

The herbicidal compositions according to the present invention typically comprise the components (A) and (B) in the following amounts:
Component (A) in an amount in the range of from about 3.0 wt. % to about 4.0 wt. %, and
Component (B) in an amount in the range of from about 4.5 wt. % to about 5.5 wt. %,
in each case based on the total weight of the composition.

The herbicidal compositions according to the present invention typically comprise the components (A), (B) and (C) in the composition in the following amounts:
Component (A) in an amount in the range of from about 3.0 wt. % to about 4.0 wt. %.
Component (B) in an amount in the range of from about 4.5 wt. % to about 5.5 wt. %, and
Component (C) in an amount in the range of from about 1.0 wt. % to about 3.5 wt. %,
in each case based on the total weight of the composition.

The herbicidal compositions according to the present invention typically comprise the components (A), (B) and (C) in the composition in the following amounts:
Component (A) in an amount in the range of from about 3.0 wt. % to about 4.0 wt. %.
Component (B) in an amount in the range of from about 5.0 wt. %, and
Component (C) in an amount in the range of from about 1.5 wt. % to about 3.0 wt. %,
in each case based on the total weight of the composition.

In some embodiments, the total amount of component (A) is about 3.2 wt. %, about 3.6 wt. % or 4.0 wt. %, in each case based on the total weight of the composition.

In some embodiments, the total amount of component (C) is about 1.5 wt. % or about 3.0 wt. %, in each case based on the total weight of the composition.

The herbicidal compositions according to the present invention may comprise or else be used together with additional, further components, examples being active crop protection ingredients of other kinds and/or adjuvants customary in the art of agrochemical formulation and/or formulating assistants.

Thus, the herbicidal compositions according to the present invention typically additionally comprise one or more further constituents selected from the group consisting of water and formulation adjuvants (formulation auxiliaries).

The herbicidal compositions according to the present invention generally have a water content in a total amount in the range of from about 45 wt. % to about 80 wt. %, typically in a total amount in the range of from about 50 wt. % to about 75 wt. %, or in a total amount in the range of from about 55 wt. % to about 70 wt. %, in each case based on the total weight of the composition.

Before their application, the herbicidal compositions according to the present invention are typically diluted with water to form a ready-to-use spray application mixture. Such a spray application mixture may be typically obtained by mixing 3 oz (about 88.7206 mL) of the herbicidal composition according to the present invention per gallon (about 3.78541 Liters) of water. Thus, typically the herbicidal composition according to the present invention is mixed with water in a ratio by volume of about 1:42.6 (v/v).

In a further aspect, the present invention relates to a ready-to-use spray application mixture, obtainable or obtained by diluting the herbicidal composition according to the present invention with water, generally in a ratio by volume (v/v) in the range of from about 1:25 to about 1:60, typically in a ratio by volume (v/v) in the range of from about 1:35 to about 1:50.

Typically, the herbicidal compositions according to the present invention comprise water and one or more further constituents selected from the group consisting of formulation adjuvants.

In certain preferred embodiments, the herbicidal compositions according to the present invention comprise water and one or more further constituents selected from the group consisting of formulation adjuvants selected from the group consisting of surfactants, emulsifiers, dispersants, organic solvents, anti-freeze agents, pH-regulation agents, biocides and antifoam agents.

In certain preferred embodiments, the herbicidal compositions according to the present invention comprise water and two, three, four or more further constituents selected from the group consisting of formulation adjuvants selected from the group consisting of surfactants, emulsifiers, organic solvents, pH-regulation agents, biocides and antifoam agents.

The herbicidal compositions according to the present invention may comprise one or more surfactants and/or emulsifiers. Useful surfactants and/or emulsifiers include: for example non-ionic and anionic emulsifiers, such as (polyoxyethylene) fatty acid esters, (polyoxyethylene) fatty alcohol ethers, e.g. alkylaryl polyglycol ethers, alkylsulphonates, alkyl sulphates, arylsulphonates and protein hydrolysates.

The herbicidal compositions according to the present invention typically comprise one or more non-ionic surfactants, typically selected from the group consisting of polyethoxylated (POE) fatty acid esters, polyethoxylated (POE) fatty alcohols, tristyrylphenol polyethoxylates, polyethoxylated (POE) amines, and mixtures thereof.

A polyethoxylated non-ionic surfactant in the context of the present invention is non-ionic surfactant with a degree of ethoxylation of at least about 2.

In certain preferred embodiments, the herbicidal compositions according to the present invention comprise one or more non-ionic surfactants selected from the group consisting of polyethoxylated castor oils, typically with a degree of ethoxylation in the range of from about 10 to about 40 (i.e. from about POE 10 to about POE 40), for example available as Agnique® CSO-25 castor oil ethoxylate, POE-25) or Agnique® CSO-30 (castor oil ethoxylate, POE-30) from Cognis/BASF, or Toximul® 8242 (castor oil ethoxylate, POE-40) from Stepan. In certain embodiments, polyethoxylated castor oils with POE 25 or POE 30 are preferred.

In certain preferred embodiments, the herbicidal compositions according to the present invention comprise one or more non-ionic surfactants selected from the group consisting of tristyrylphenol polyethoxylates, typically with a degree of ethoxylation in the range of from about 10 to about 20 (i.e. from about POE 10 to about POE 20), for example available as Makon® TSP-12 (tristyrylphenol ethoxylate, POE-12) or Makon® TSP-16 (tristyrylphenol ethoxylate, POE-12) from Stepan.

In certain preferred embodiments, the herbicidal compositions according to the present invention comprise one or more non-ionic surfactants selected from the group consisting of fatty acids polyethoxylates, such as polyethoxylated tall oil fatty acids, typically with a degree of ethoxylation in the range of from about 2 to about 10 (i.e. from about POE 2 to about POE 10), for example available as Ninex® MT-603 (fatty acids (tall oil) ethoxylate, POE-3) from Stepan.

In certain preferred embodiments, the herbicidal compositions according to the present invention comprise one or more non-ionic surfactants selected from the group consisting of polyethoxylated (POE) alkyl amines, typically polyethoxylated (POE) C₈-C₁₈ alkyl amines, more typically polyethoxylated (POE) n-C₅-C₁₈ alkyl amines. Useful polyethoxylated (POE) n-C₈-C₁₈ alkyl amines in the context of the present invention include cocoamine polyethoxylates, typically with a degree of ethoxylation in the range of from about 2 to about 20 (i.e. from about POE 2 to about POE 20), such as cocoamine, ethoxylated, POE 10-15, cocoamine, ethoxylated, POE 2, cocoamine, ethoxylated, POE 5 or cocoamine, ethoxylated, POE 7.5.

Suitable C₈-C₁₈ alkyl alcohol polyethoxylates are for example isodecyl alcohol ethoxylate POE 6, for example available as Makon® DA-6 from Stepan.

The herbicidal compositions according to the present invention typically comprise one or more surfactants, typically one or more non-ionic surfactants, in a total amount in the range of from about 10 wt. % to about 30 wt. %, typically in an amount in the range of from about 12 wt. % to about 25 wt. %, more typically in an amount in the range of from about 15 wt. % to about 22 wt. %, in each case based on the total weight of the composition.

The herbicidal compositions according to the present invention may comprise one or more organic solvents. Useful organic solvents are liquid at 25° C. and 1013 mbar, and may be selected from aromatics, such as xylene, toluene or alkylnaphthalenes, chlorinated aromatics or chlorinated aliphatic hydrocarbons, such as chlorobenzenes, chloroethylenes or methylene chloride, aliphatic hydrocarbons, such as cyclohexane or paraffins, for example petroleum fractions, mineral oils and vegetable oils, alcohols, such as butanol, glycerine or alkylene glycols, such as propylene glycol, dipropylene glycol, and the ethers and esters of alcohols or alkylene glycols, ketones, such as acetone, methyl ethyl ketone, methyl isobutyl ketone or cyclohexanone, and strongly polar solvents, such as dimethylformamide or dimethyl sulphoxide.

If the herbicidal compositions according to the present invention comprise one or more organic solvents, the total amount of organic solvents generally is in the range of from about 2 wt. % to about 20 wt. %, typically in the range of from about 5 wt. % to about 15 wt. %, more typically in the range of from about 8 wt. % to about 12 wt. %, in each case based on the total weight of the composition.

In certain embodiments, the herbicidal compositions according to the present invention comprise one or more organic solvents selected from the group consisting of C₄-C₁₂ alkanols, C₄-C₁₂ alkylene glycols and C₄-C₁₂ fatty acids, and mixtures thereof.

In certain embodiments, the herbicidal compositions according to the present invention comprise one or more organic solvents selected from the group consisting of primary C₄-C₁₂ alkanols, C₄-C₁₂ alkane 1,2-diols and primary C₄-C₁₂ alkanoic acids, and mixtures thereof.

In certain embodiments, the herbicidal compositions according to the present invention comprise one or more organic solvents selected from the group consisting of primary straight chain C₆-C₁₀ alkanols (C₆-C₁₀ n-alkanols), straight chain C₆-C₁₀ alkane 1,2-diols (C₆-C₁₀ n-alkane 1,2 diols) and primary straight chain C₆-C₁₀ alkanoic acids (C₆-C₁₀ n-alkanoic acids), and mixtures thereof.

The effect observed when one or more organic solvents selected from the group consisting of C₄-C₁₂ alkanols, C₄-C₁₂ alkylene glycols and/or C₄-C₁₂ fatty acids are included in the herbicidal compositions according to the present invention is that the compositions remain visually clear for a significant longer period of time, i.e. do not become hazy or turbid compared to otherwise identical compositions lacking said organic solvent. Incorporating one or more organic solvents selected from the group consisting of C₄-C₁₂ alkanols, C₄-C₁₂ alkylene glycols and/or C₄-C₁₂ fatty acids into the herbicidal compositions according to the present invention not only improves the stability of the compositions according to the present invention, but also allow a decrease or lowering of the amount of surfactants required to form stable compositions compared to otherwise identical compositions lacking said organic solvent.

In certain preferred embodiments, the herbicidal compositions according to the present invention comprise one or more organic solvents selected from the group consisting of 1-hexanol, 1-octanol, 2-ethylhexanol, 1-decanol, iso-decanol and 1-dodecanol, and mixtures thereof. In certain preferred embodiments, the herbicidal compositions according to the present invention comprise one or more organic solvents selected from the group consisting of 1-hexanol, 1-octanol, 1-decanol, and 1-dodecanol, and mixtures thereof. In certain embodiments, 1-octanol is preferred.

In certain preferred embodiments, the herbicidal compositions according to the present invention comprise one or more organic solvents selected from the group consisting of 1-hexanoic acid, 1-octanoic acid, 1-decanoic acid and 1-dodecanoic acid, and mixtures thereof. In certain embodiments, 1-octanoic acid is preferred.

Generally, C₄-C₁₂ alkanols, C₄-C₁₂ alkylene glycols and C₄-C₁₂ fatty acids are suitable to be incorporated into the herbicidal compositions according to the present invention, and generally also allowed the formation of a microemulsion. In comparison, straight chain C₄-C₁₂ alkanols, straight chain C₄-C₁₂ alkylene glycols and straight chain C₄-C₁₂ fatty acids have shown to be superior in the formation of herbicidal compositions of the present invention in the form of a microemulsion compared to the corresponding branched chain solvents. For example, compared to otherwise identical compositions comprising iso-decanol or 2-ethylhexanol, compositions comprising 1-dodecanol or 1-octanol showed superior physical stability and were stable for longer period of time under the same storage conditions.

If the herbicidal compositions according to the present invention comprise one or more organic solvents selected from the group consisting of C₄-C₁₂ alkanols, C₄-C₁₂ alkylene glycols and C₄-C₁₂ fatty acids, the total amount of these solvents generally is in the range of from about 1.0 wt. % to about 10.0 wt. %, typically in the range of from about 3.0 wt. % to about 8.0 wt. %, more typically in the range of from about 4.0 wt. % to about 6.0 wt. %, in each case based on the total weight of the composition.

If the herbicidal compositions according to the present invention comprise one or more organic solvents selected from the group consisting of primary straight chain C₆-C₁₀ alkanols, straight chain C₆-C₁₀ alkane 1,2-diols and primary straight chain C₆-C₁₀ alkanoic acids, the total amount of these solvents generally is in the range of from about 1.0 wt. % to about 10.0 wt. %, typically in the range of from about 3.0 wt. % to about 8.0 wt. %, more typically in the range of from about 4.0 wt. % to about 6.0 wt. %, in each case based on the total weight of the composition.

In some embodiments, the herbicidal compositions according to the present invention comprise one or more polyethylene glycols, typically polyethylene glycol 400 (PEG 400), as organic solvent.

In some embodiments, the herbicidal compositions according to the present invention comprise one or more polyethylene glycols with a molar mass in the range of from about 250 to about 800 g/mol.

In other embodiments, the herbicidal compositions according to the present invention comprise one or more polyethylene glycols with a molar mass in the range of from about 300 to about 600 g/mol.

In typical embodiments, the herbicidal compositions according to the present invention comprise one or more polyethylene glycols with a molar mass in the range of from about 350 to about 450 g/mol.

In more typical embodiments, the herbicidal compositions according to the present invention comprise polyethylene glycol 400 (PEG 400).

If present, the total amount of polyethylene glycols, in particular of polyethylene glycol 400, in the herbicidal compositions of the present invention generally is in the range of from about 2.0 wt. % to about 10 wt. %, typically in the range of from about 3.0 wt. % to about 8.0 wt. %, more typically in the range of from about 4.0 wt. % to about 6.0 wt. %, in each case based on the total weight of the composition.

In certain embodiments, the herbicidal compositions according to the present invention comprise one or more polyethylene glycols, in particular polyethylene glycol 400, and one or more organic solvents selected from the group consisting of C₄-C₁₂ alkanols, C₄-C₁₂ alkylene glycols and C₄-C₁₂ fatty acids. In other embodiments, the herbicidal compositions according to the present invention comprise one or more polyethylene glycols, in particular polyethylene glycol 400, and one or more organic solvents selected from the group consisting of primary C₄-C₁₂ alkanols, wherein the primary C₄-C₁₂ alkanols in preferred embodiments are selected from the group consisting of 1-hexanol, 1-octanol, 1-decanol and 1-dodecanol. In other embodiments, the herbicidal compositions according to the present invention comprise one or more polyethylene glycols, in particular polyethylene glycol 400, and one or more organic solvents selected from the group consisting of primary straight chain C₆-C₁₀ alkanoic acids, wherein the primary straight chain C₆-C₁₀ alkanoic acids in preferred embodiments are selected from the group consisting of 1-hexanoic acid, 1-octanoic acid, 1-decanoic acid and 1-dodecanoic acid.

If the herbicidal compositions according to the present invention comprise polyethylene glycols, in particular polyethylene glycol 400, and one or more organic solvents selected from the group consisting of primary C₄-C₁₂ alkanols, the primary C₄-C₁₂ alkanols are preferably selected from the group consisting of 1-hexanol, 1-octanol, 1-decanol and 1-dodecanol, the ratio by weight of the total amounts generally is in the range of from 3:1 to 1:3, typically in the range of from 2:1 to 1:2, more typically in the range of from 3:2 to 2:3. In some embodiments, said ratio is about 1:1.

If the herbicidal compositions according to the present invention comprise polyethylene glycols, in particular polyethylene glycol 400, and one or more organic solvents selected from the group consisting of primary straight chain C₆-C₁₀ alkanoic acids, preferably the primary straight chain C₆-C₁₀ alkanoic acids are selected from the group consisting of 1-hexanoic acid, 1-octanoic acid, 1-decanoic acid and 1-dodecanoic acid, the ratio by weight of the total amounts generally is in the range of from 3:1 to 1:3, typically in the range of from 2:1 to 1:2, more typically in the range of from 3:2 to 2:3. In some embodiments, said ratio is about 1:1.

The herbicidal compositions according to the present invention may comprise one or more antifoam agents, typically one or more silicone-based antifoam agents, in turn typically silicone-based antifoam emulsions and polydimethylsiloxane-based antifoam emulsions, for example the commercially available antifoam agents SAG 10 or SAG 1572 available from Momentive Performance Materials.

The herbicidal compositions according to the present invention may comprise one or more biocides. A biocide is a substance used for the control of organisms that are harmful and would cause damage to the compositions of the present invention, i.e. used for the preservation of the compositions of the present invention. A preferred biocide in the context of the present invention is an antimicrobial, typically 1,2-benzisothiazolin-3-one, as for example commercially available from Lonza, e.g. as Proxel® GXL (a 20 wt. % solution of 1,2-benzisothiazolin-3-one in aqueous dipropylene glycol.

The herbicidal compositions according to the present invention typically have a pH-value in the range of from about 5 to about 9, typically in the range of from about 5.5 to about 8.5.

The pH-value to some extent depends on the presence of optional constituents such as for example the type and amount of the organic solvents, if present.

If the herbicidal compositions according to the present invention comprise C₄-C₁₂ alkanols, such as 1-hexanol or 1-octanol, the pH-value typically is in the range of from about 6.5 to about 8.5, more typically in the range of from about 6.8 to about 8.2. Oftentimes, the pH-value is in the range of from about 7.0 to about 8.0.

If the herbicidal compositions according to the present invention comprise C₄-C₁₂ fatty acids, such 1-octanoic acid, the pH-value typically is in the range of from about 5.0 to about 7.0, more typically of from about 5.5 to about 6.0.

The pH-values indicated in the context of the present invention refer to measurements at 25° C. and 1013 mbar.

The pH-value of a herbicidal composition according to the present invention was measured using conventional pH measuring equipment, typically by immersing the probe of a pH meter into a sample of the composition. Prior to measuring pH of the composition, the pH meter was calibrated in accordance with the manufacturer's recommended protocol.

The herbicidal compositions according to the present invention may comprise one or more pH-regulation agents, typically one or more acids, in turn typically one or more organic acids, in certain preferred embodiments citric acid.

If present in the herbicidal compositions according to the present invention, the pH-regulation agents are present in an amount needed to achieve the pH-value of the compositions as indicated above. Typically, an amount of citric acid is used in the range of from about 0.005 wt. % to about 0.15 wt. %, more typically in the range of from about 0.01 wt. % to about 0.1 wt. %, in each case based on the total weight of the composition.

The herbicidal compositions according to the present invention may comprise one or more dispersants. Useful dispersants include: for example lignosulphite waste liquors and methylcellulose.

The herbicidal compositions according to the present invention may comprise one or more solid carriers. Useful solid carriers include: for example ammonium salts and ground natural minerals, such as kaolins, clays, talc, chalk, quartz, attapulgite, montmorillonite or diatomaceous earth, and ground synthetic minerals, such as finely divided silica, alumina and silicates; other useful solid carriers include for example crushed and fractionated natural rocks, such as calcite, marble, pumice, sepiolite, dolomite or organic solid carrier materials, such as sawdust, coconut shells, maize cobs and tobacco stalks.

The herbicidal compositions according to the present invention may comprise one or more tackifiers. It is possible to use tackifiers such as carboxymethylcellulose, natural and synthetic polymers in the form of powders, granules or latices, such as xanthan gum, gum arabic, polyvinyl alcohol and polyvinyl acetate, or else natural phospholipids such as cephalins and lecithins and synthetic phospholipids.

The herbicidal compositions according to the present invention may comprise one or more colorants. It is possible to use colorants such as inorganic pigments, for example iron oxide, titanium oxide and Prussian Blue, and organic dyes, such as alizarin dyes, azo dyes and metal phthalocyanine dyes.

The compositions of the present invention typically are aqueous herbicidal liquid compositions at 25° C. and 1013 mbar, typically in the form of an oil-in-water emulsion, more typically in the form of an oil-in-water microemulsion.

Depending inter alia on the requirements of the unwanted (weed) plants present or expected in the area to be treated, it may be desired or necessary to further complement and optimize the weed control spectrum of the compositions of the present invention, the herbicidal compositions according to the present invention may be combined with one or more further herbicides. Thus, the herbicidal compositions according to the present invention may additionally comprises one or more further herbicides.

Typically, the herbicidal compositions according to the present invention do not contain, i.e. are free of, glyphosate, esters and salts thereof, and free of dicamba, esters and salts thereof.

Typically, the herbicidal compositions according to the present invention do not contain, i.e. are free of, 2,4-D, esters and salts thereof.

However, in certain preferred embodiments the herbicidal composition according to the present invention the components (A) and (B), and optionally component (C), are the only herbicidal active ingredients present in the composition.

Certain preferred herbicidal compositions of the present invention are those containing component (A), component (B), and component (C) as only active agrochemical ingredients.

Further herbicides optionally incorporated into or mixed with the herbicidal compositions of the present invention and the common names used herein are known in the art; see, for example, “The Pesticide Manual” 16^{th} Edition, British Crop Protection Council 2012; these include the known stereoisomers (in particular racemic and enantiomeric pure isomers) and derivatives such as salts or esters, and particularly the commercially customary forms. Where a herbicide is referenced generically herein by name, unless otherwise restricted, that herbicide includes all commercially available forms known in the art such as salts, esters, free acids and free bases, as well as stereoisomers thereof.

The term “locus” of a weed plant(s) (i.e. the unwanted plant(s)) comprises the weed plant(s), part of the weed plants, seed of the weed plants or the area where the weed plants are growing or will be growing. Thus, the term “locus” includes the (natural) soil, which is typically present on a land area, including soil that has been modified, such as soil that has been granulated and/or treated with agrochemicals, such as for example fertilizers.

The compositions of the present invention are used for controlling undesired plants, i.e. for weed control. This activity allows to apply the compositions of the present invention as effective herbicidal active products pre- and post-emergence, related to the emergence of the weeds, for controlling broad-leaved (dicotyledonous) weeds and grass (monocotyledonous) weeds as herbicide.

The compositions of the present invention are non-selective weed control compositions and for example can be used as burndown herbicide compositions for so-called burndown weed control.

In certain preferred embodiments, the compositions of the present invention are applied pre-emergence related to the emergence of the unwanted plant (weed).

In other preferred embodiments, the compositions of the present invention are applied post-emergence related to the emergence of the unwanted plant (weed).

The herbicidal compositions based on the herbicidal active ingredients (A) and (B), and preferably (C), as defined in the context of the present invention mainly have post-emergence activity and therefore typically are applied early post-emergence or post-emergence related to the emergence of the unwanted plants (weeds).

The herbicidal compositions based on the herbicidal active ingredients (A) and (B), and preferably (C), as defined in the context of the present invention have both pre-emergence and post-emergence activity and are therefore typically are applied pre-emergence, early post-emergence or post-emergence to the emergence of the unwanted plants (weeds), ie these compositions can be applied to the entire area intended to remain weed-free with or without post-emergent weeds being present.

The compositions typically are applied to the (locus of the) weed plants as a sprayable liquid. The compositions of the present invention are typically applied to the locus of the unwanted plant(s) by spraying the liquid (sprayable) compositions with spray equipment such as knapsack sprayer, hose end applicators or RTU pump sprayers.

Treatment of the (areas of) undesired plant growth may typically be performed by operators, greenkeepers, gardeners or home owners.

The compositions of the present invention can be used for controlling various kinds of weeds developing in the areas mentioned above.

The compositions of the present invention have an excellent herbicidal activity against a broad range of important monocotyledonous and dicotyledonous harmful plants in the field of environmental health. The compositions of the present invention also act efficiently on perennial weeds which produce shoots from rhizomes, root stocks or other perennial organs and which are difficult to control.

The compositions of the present invention show excellent controlling effect against a wide range of weeds such as annual or perennial gramineae, said gramineae typically belong to one or more of the genera Agropyron, Agrostis, Axonopus, Bromus, Buchloe, Cynodon, Eremochloa, Festuca, Lolium, Paspalum, Pennisetum, Phleum, Poa, Stenotaphrum or Zoysia.

Examples of the unwanted plant (weed) species to be controlled are the following:

Monocotyledonous weeds such as: Digitaria ciliayis (Retz.) Koeler, Eleusine indica (L.) Gaertn., Digitaria sanguinalis (L.) Scop. Setaria viridis (L.) Beauv. var. viridis, Poa annua L., Alopecurus aequalis Sobol. var. amurensis, Imperata cylindrica (L.) Beau., Luzula capitata (Mig.) Mig, Cyperus rotundus L., Cyperus brevifolius (Rottb.) Hassk. var. leiolepis, Digitaria radicosa (Presl) Mig., Digitaria violascens Link), Setaria faberii Herrm, Holcus lanatus, etc.

Dicotyledonous weeds such as: Rumex japonicus Houtt., Portulaca oleracea L. var. oleracea, Stellaria neglecta Weihe, Kummerowia striata (Thunb. ex Murray) Schindl., Euphorbia supina Rafin, Galinsoga ciliata (Rafin.) Blake, Cerastium glomeratum Thuill., Stellaria alsine Grimm. var. undulata (Thunb. ex Murray) Ohwi, Cardamine flexuosa With., Capsella bursa-pastoris Medicus, Lamium amplexicaule L., Veronica persica Poir., Veronica filiformis, Aster maaekii Regel, Oxalis corniculata L., Hydrocotyle sibthorpioides Lam., Plantago asiatica L., Plantago lanceolata L., Plantago media, Plantago major, Artemisia indica Willd. var. maximowiczii (Nakai) Hara, Erigeron philadelphicus L., Rumex acetosa L., Taraxacum officinale Weber, Bellis perennis, Achilea millefolia, Crepis capillaris, Prunella vulgaris, Ranunculus repens, Ranunculus acris, Trifolium repens, Trifolium dubium, Potentilla spp. etc.

Examples of weed species that are controlled by the compositions of the present invention are in particular BLATA (Calyptocarpus vialis, sprawling horseweed), BOTIS (Bothriochloa ischaemum var. songarica), CYNDA (Cynodon dactylon, bermudagrass), DIGSA (Digitaria sanguinalis, large crabgrass), FESAR (Schedonorus arundinaceus, Festuca elatior var. arundinacea, Lolium arundinaceum, tall fescue), FRAVI (Fragaria virginiana, wild strawberry), LESST (Kummerowia striata, common lespedeza), OXACO (Oxalis corniculata, creeping woodsorrel), PASNO (Paspalum notatum, bahiagrass), PLALA (Plantago lanceolata, buckhorn plantain), POAPR (Poa pratensis, Kentucky bluegrass), POROL (Portulaca oleracea, common purslane), PYLUR (Phyllanthus urinaria, chamber bitter), RUMCR (Rumex crispus, curly dock), SETVI (Setaria viridis, green foxtail), STPSE (Stenotaphrum secundatum, St. Augustinegrass), TAROF (Taraxacum officinale, dandelion), TOXRA (Toxicodendron radicans, poison ivy), TRFPR (Trifolium pratense), TRFRE (Trifolium repens, white clover), and URTUR (Urtica urens, burning nettle).

The use of the compositions of the present invention, however, should not be restricted to these weeds in any way, but can be applied against other weeds in the same manner.

If the herbicidal compositions according to the present invention are applied to the soil surface before germination, i.e. pre-emergence of the unwanted plants (weeds), then the unwanted plant seedlings are either prevented completely from emerging or the unwanted plants grow until they have reached the cotyledon stage, but then their growth stops and they finally die completely after three to four weeks have elapsed.

When the herbicidal compositions according to the present invention are applied post-emergence to the green parts (in particular the foliage) of the plants, growth stops over time after treatment and the weed plants remain at the stage of growth at the time of application, or they die completely after a certain time, thereby the weed plants are eliminated at an early stage and in a sustained manner.

It is also possible to use the compositions of the present invention in combination (e.g. sequentially) with other pesticidally active substances or nutritients, such as, for example, insecticides, acaricides, fungicides, fertilizers and/or growth regulators.

In a further aspect, the present invention relates to a method for controlling weed plants in useful plants, characterized in that a herbicidal composition according to the present invention is applied to the weed plants, plants, plant seeds, or to the area on which the weed plants are growing or will be growing.

In a further aspect, the present invention relates to the use of a herbicidal composition according to the present invention for controlling unwanted plants, optionally unwanted plants growing in areas of useful plants.

The present invention thus also provides for the use of the herbicidal compositions of the invention for controlling unwanted plant growth, i.e. for killing of unwanted plants or for controlling the growth and proliferation of unwanted plants.

When the herbicidal compositions of the invention are used, a very broad spectrum of weed plants are controlled pre-emergence and post-emergence, examples being annual and perennial monocotyledonous or dicotyledonous weeds, and also unwanted crop plants.

The method or use according to the present invention can be carried out pre-emergence, early post-emergence or post-emergence of the unwanted plants (weeds).

The present invention accordingly further provides a method for controlling unwanted plants that is characterized in that components (A) and (B), and optionally (C), of the herbicidal compositions of the invention are applied to the plants (e.g. weed plants such as monocotyledonous or dicotyledonous weeds or unwanted crop plants) or to the area on which the plants are growing or can be expected to be growing.

The compositions of the present invention can be applied in many areas, sites and locations, such as for example hardscapes, patios, walkways, driveways, gravel areas, mulch beds, in landscape beds, around vegetable gardens, in or around flower beds, in or around landscape(d) areas, around perennial landscape plants, flower gardens, ornamental gardens, around trees and shrubs (e.g. plantations and orchards), along fences and foundations, edging around foundations, buildings or retaining walls, wooded or vacant lots, recreational areas, fields, trails, parks, sports facilities, xeriscapes, desert landscapes, rockgardens, around homes, buildings, cabins, lodges or camp sites, vines growing up poles, mature trees, trunks or freshly cut woody stumps.

In a further aspect, the present invention relates to methods and uses as defined in the context of the present invention, wherein a herbicidal composition according to the present invention is applied to unwanted plants in the field of environmental health, typically hardscapes or landscapes roadsides, driveways, patios, sidewalks, gravel areas, parks, public gardens, private gardens, plantations, orchards, sports grounds, arenas, mulch beds, in or around flower beds, in or around landscape(d) areas, around perennial landscape plants, around trees and shrubs (e.g. plantations and orchards), along fences and foundations, edging around foundations, buildings or retaining walls, wooded or vacant lots, recreational areas, fields, trails, parks, sports facilities, xeriscapes, desert landscapes, rockgardens, around homes, buildings, cabins, lodges or camp sites, vines growing up poles, mature trees, trunks or freshly cut woody stumps.

By unwanted plants are meant all plants that are growing at locations where they are unwanted. These may be, for example, weed plants (e.g. monocotyledonous or dicotyledonous weeds or unwanted crop plants).

The application or use rates of the herbicidal active ingredients present in compositions of the present invention typically are
for Component (A) from about 1000 to about 2000 g/ha, and/or
for Component (B) from about 1000 to about 2500 g/ha.

The application or use rates of the herbicidal active ingredients present in compositions of the present invention typically are
for Component (A) from about 1200 to about 1500 g/ha, and/or
for Component (B) from about 1500 to about 1800 g/ha.

According to the methods or uses according to the present invention the components (A) and (B), and optionally (C), are applied together as a single composition, i.e. as a premix composition.

If the compositions of the present invention are in the form of a concentrate, said concentrate are typically diluted with an appropriate amount of water before being applied pre-emergence to the area where weed plants will be growing of to the foliage of the weed plants if applied post-emergence of the weed plants.

In a further aspect the present invention provides for a method of manufacturing a composition of the present invention, wherein Component (A) is mixed with Component (B), and optionally with Component (C), typically in this order, and further constituents present in the composition.

The herbicidal compositions of the invention can be produced by other known methods, for example as mixing of the individual components with adjuvants and/or customary formulation assistants to form premix combinations. These premix combinations being then employed in a customary way, for example as dilutions with water. They may also be produced in the form of what are called tank mixes, by joint dilution of the separately formulated or partially separately formulated individual components with water.

The components (A) and (B), and optionally (C), can be converted together or separately into application formulations, for example for application by spraying, watering and sprinkling, such as solutions, emulsions, suspensions, powders, foams, pastes, granules, and other forms known in the art. The formulations may comprise the customary auxiliaries and adjuvants such as those mentioned above.

These formulations are produced in a known manner, for example by mixing the components (A) and (B), and optionally (C), with customary auxiliaries and adjuvants, typically those mentioned above.

The herbicidal compositions or formulations according to the present invention comprising components (A) and (B), and if present component (C), can also be used as a mixture with other agrochemically active ingredients for controlling unwanted plant growth, for example for controlling weeds.

Also possible are mixtures with other known active ingredients such as fungicides, insecticides, acaricides, nematicides, bird antifeedants, plant nutrients and soil improvers, and likewise with (other) adjuvants and (other) formulation assistants customary in agrochemical formulation.

The herbicidal compositions or formulations according to the present invention comprising components (A) and (B), and if present component (C), can be used in the form of their formulations or the use forms prepared therefrom by further dilution, such as ready-to-use solutions, suspensions, emulsions, powders, pastes and granules. Application is typically accomplished, for example, by watering, sprinkling, spraying, broadcasting.

The herbicidal compositions or formulations according to the present invention comprising components (A) and (B), and if present component (C), can be deployed on the plants, plant parts, typically on the green plants and plant parts. One means of the deployment of premix combination, optionally diluted with water in a tank mix. Another means of application is application is the co-deployment of the active ingredients in the form of tank mixes, by mixing the optimally formulated concentrated formulations of the individual active ingredients together in the tank with water and deploying the spray liquor obtained.

### EXAMPLES

Unless indicated otherwise, all amounts and percentages are by weight.

The materials used and meanings of the abbreviations are as follows:
Agnique® CSO-25=Emulsifier ethoxylated castor oil, POE 25 (BASF)
Cocoamine=Cocoamine, ethoxylated, POE 2 (CAS Reg. No. 61791-31-9) (e.g. from Akzo Nobel/Nouryon or Stepan)
DI Water=Deionized water
Makon® TSP-12=Surfactant tristyrylphenol ethoxylate, POE-12 (CAS Reg. No. 99734-09-5) (Stepan)
Makon® TSP-16=Surfactant tristyrylphenol ethoxylate, POE-16 (CAS Reg. No. 99734-09-5) (Stepan)
Ninex® MT-603=Surfactant fatty acids (tall oil) ethoxylate, POE-3 (CAS Reg. No. 61791-00-2) (Stepan)
PEG 400=Polyethylene glycol 400
Proxel® GXL=Biocide solution of 20% of 1,2-benzisothiazolin-3-one containing in aqueous dipropylene glycol (Lonza)
SAG 1572=Polydimethylsiloxane-based antifoam emulsion (Momentive performance materials), 15-20% actives content
Triclopyr TEA=Triclopyr triethylamine salt (used as 44.4% solution in water)
Toximul® 8242=Surfactant; castor oil ethoxylate, POE-40 (CAS Reg. No. 61791-12-6) (Stepan)
Conc.=Concentrate
DAT=Days after treatment
oz=US fluid ounce (29.5735 mL)
RTU=Ready-to-use
UTC=Untreated control
wt. %=Constituent weight percentage relative to the respective composition
Roundup® L&G RTU=Commercial product containing 2% glyphosate and 2% pelargonic acid
Spectracide™ RTU=Commercial product Spectracide™ Weed & Grass Killer2 (Ready-To-Use) containing 0.12% diquat dibromide, 0.06% fluazifop-p-butyl, and 0.04% dicamba dimethylamine salt
DIGSA=Digitaria sanguinalis
LOLPE=Lolium perenne
POROL=Portulaca oleracea
TRFRE=Trifolium repens

### Method of Preparation of the Compositions of the Present Invention, in Particular the Compositions Shown in Tables 1 to 8:

In a first vessel equipped with a mixer, the non-ionic surfactant(s) as indicated in the respective composition, the one or more organic solvents, and any further optionally present non-polar constituents, were charged and the mixer started,

Fluazifop P-Butyl technical grade (about 96.8% purity) was added and mixed for at least 10 minutes until fully dissolved, typically for about 15-20 minutes.

In a second vessel equipped with a mixer, a solution was prepared with continued mixing for at least 10 minutes, typically for about 15-20 minutes, comprising the following constituents:
Triclopyr TEA solution (about 44.4% in water),
Diquat Dibromide (about 37.8% in water), if present,
DI water, and
any further optionally present polar constituents.

Subsequently, the mixture from the first vessel was added to the mixture in the second vessel with stirring, and mixing was continued for at least 10 minutes, typically for about 15-20 minutes. To the resulting the (micro)emulsion were added:
Biocide (Proxel® GXL), and
Antifoam (SAG 1572),

Finally, if present, Citric acid (used as 5% or as 50% solution in water) was added to adjust the pH of the (micro)emulsion.

Depending on the size of the vessel, the compositions shown in Tables 1 to 8 were obtained by stirring with a mixer using mixing speeds typically in the range of from about 200 rpm to about 600 rpm, depending on the size of the vessels used.

### Compositions of the Present Invention:

Compositions of the present invention are shown in Tables 1 to 8. The compositions shown in Tables 1 to 8 were oil-in-water microemulsions.

The compositions of the present invention shown in Tables 1 to 3 contain two herbicidal active ingredients: components (A) and (B) as defined in the context of the present invention.

The composition of the present invention shown in Tables 4 to 8 contain three herbicidal active ingredients: components (A), (B) and (C) as defined in the context of the present invention.

TABLE 1
Concentrate compositions

| | | C52 (wt. | | C92 (wt. |
|---|---|---|---|---|
| | C52 | % actives | C92 | % actives |
| Constituent | (wt. %) | content) | (wt. %) | content) |
| Fluazifop P-butyl | 4.13% | 4.00% | 4.13% | 4.00% |
| Triclopyr TEA | 11.25% | 5.00% | 11.25% | 5.00% |
| Agnique ® CSO-25 | 19.27% | 19.27% | 9.50% | 9.50% |
| Makon ® TSP-16 | — | — | 9.50% | 9.50% |
| Ninex ® MT-603 | — | — | 2.07% | 2.07% |
| PEG 400 | 5.00% | 5.00% | — | — |
| 1-Octanol | 4.13% | 4.13% | 2.07% | 2.07% |
| Proxel ® GXL | 0.10% | 0.10% | 0.10% | 0.10% |
| SAG 1572 | 0.01% | 0.01% | 0.01% | 0.01% |
| DI Water | 56.11% | 62.49% | 61.37% | 67.75% |
| Total: | 100.00% | 100.00% | 100.00% | 100.00% |
| Citric Acid | — | — | 0.01% | 0.01% |
| pH-value | 7.78 | 7.78 | 7.81 | 7.81 |

TABLE 2
Concentrate compositions

| | | C95 (wt. | | C102 (wt. |
|---|---|---|---|---|
| | C95 | % actives | C102 | % actives |
| Constituent | (wt. %) | content) | (wt. %) | content) |
| Fluazifop P-butyl | 4.13% | 4.00% | 4.13% | 4.00% |
| Triclopyr TEA | 11.25% | 5.00% | 11.25% | 5.00% |
| Agnique ® CSO-25 | 19.00% | 19.00% | 13.40% | 13.40% |
| Makon ® TSP-12 | 2.07% | 2.07% | — | — |
| Makon ® TSP-16 | — | — | 3.35% | 3.35% |
| PEG 400 | — | — | 5.00% | 5.00% |
| 1-Octanol | 2.07% | 2.07% | 3.35% | 3.35% |
| Proxel ® GXL | 0.10% | 0.10% | 0.10% | 0.10% |
| SAG 1572 | 0.01% | 0.01% | 0.01% | 0.01% |
| DI Water | 61.37% | 67.75% | 59.41% | 65.79% |
| Total: | 100.00% | 100.00% | 100.00% | 100.00% |
| pH-value | 7.30 | 7.30 | 7.81 | 7.81 |

TABLE 3
Concentrate compositions comprising Cocoamine, Toximul ® 8242
and Makon ® TSP-16

| | | C70 (wt. | | C100 (wt. |
|---|---|---|---|---|
| | C70 | % actives | C100 | % actives |
| Constituent | (wt. %) | content) | (wt. %) | content) |
| Fluazifop P-butyl | 4.13% | 4.00% | 4.13% | 4.00% |
| Triclopyr TEA | 11.25% | 5.00% | 11.25% | 5.00% |
| Cocoamine | 4.13% | 4.13% | 2.07% | 2.07% |
| Toximul ® 8242 | 9.50% | 9.50% | 9.50% | 9.50% |
| Makon ® TSP-16 | 9.50% | 9.50% | 9.50% | 9.50% |
| PEG-400 | — | — | 5.00% | 5.00% |
| 1-Octanol | — | — | 2.07% | 2.07% |
| Proxel ® GXL | 0.10% | 0.10% | 0.10% | 0.10% |
| SAG 1572 | 0.01% | 0.01% | 0.01% | 0.01% |
| DI Water | 61.38% | 67.76% | 56.37% | 62.75% |
| Total: | 100.00% | 100.00% | 100.00% | 100.00% |
| Citric Acid | 0.1% | 0.005% | 0.01% | 0.01% |
| pH-value | 7.99 | 7.99 | 7.99 | 7.99 |

TABLE 4
Concentrate compositions with three herbicidal active ingredients

| | | C103 (wt. | | C136 (wt. |
|---|---|---|---|---|
| | C103 | % actives | C136 | % actives |
| Constituent | (wt. %) | content) | (wt. %) | content) |
| Fluazifop P-butyl | 4.13% | 4.00% | 4.13% | 4.00% |
| Triclopyr TEA | 11.25% | 5.00% | 11.25% | 5.00% |
| Diquat dibromide | 7.93% | 3.00% | 3.96% | 1.50% |
| Agnique ® CSO-25 | 19.25% | 19.25% | 19.00% | 19.00% |
| PEG 400 | 5.00% | 5.00% | 5.00% | 5.00% |
| 1-Octanol | 4.13% | 4.13% | 4.13% | 4.13% |
| Proxel ® GXL | 0.10% | 0.10% | 0.10% | 0.10% |
| SAG 1572 | 0.01% | 0.01% | 0.01% | 0.01% |
| DI Water | 48.20% | 59.51% | 52.42% | 61.26% |
| Total: | 100.00% | 100.00% | 100.00% | 100.00% |
| Citric Acid | — | — | 0.01% | 0.005% |
| pH-value | 7.21 | 7.21 | 7.27 | 7.27 |

TABLE 5
Concentrate compositions with three herbicidal active ingredients

| | | C137 (wt. | | C164 (wt. |
|---|---|---|---|---|
| | C137 | % actives | C164 | % actives |
| Constituent | (wt. %) | content) | (wt. %) | content) |
| Fluazifop P-butyl | 4.13% | 4.00% | 4.13% | 4.00% |
| Triclopyr TEA | 11.25% | 5.00% | 11.25% | 5.00% |
| Diquat dibromide | 3.96% | 1.50% | 3.96% | 1.50% |
| Agnique ® CSO-25 | 19.00% | 19.00% | 13.40% | 13.40% |
| Makon ® TSP-12 | — | — | 3.35% | 3.35% |
| PEG 400 | 5.00% | 5.00% | 5.00% | 5.00% |
| 1-Octanol | — | — | 3.35% | 3.35% |
| 1-Hexanol | 4.13% | 4.13% | — | — |
| Proxel ® GXL | 0.10% | 0.10% | 0.10% | 0.10% |
| SAG 1572 | 0.01% | 0.01% | 0.01% | 0.01% |
| DI Water | 52.42% | 61.26% | 55.45% | 64.29% |
| Total: | 100.00% | 100.00% | 100.00% | 100.00% |
| pH-value | 6.84 | 6.84 | 7.19 | 7.19 |

TABLE 6
Concentrate compositions with three herbicidal active ingredients

| | | C136A (wt. | | C136B (wt. |
|---|---|---|---|---|
| | C136A | % actives | C136B | % actives |
| Constituent | (wt. %) | content) | (wt. %) | content) |
| Fluazifop P-butyl | 3.72% | 3.60% | 3.31% | 3.20% |
| Triclopyr TEA | 11.25% | 5.00% | 11.25% | 5.00% |
| Diquat dibromide | 3.96% | 1.50% | 3.96% | 1.50% |
| Agnique ® CSO-25 | 19.00% | 19.00% | 19.00% | 19.00% |
| PEG 400 | 5.00% | 5.00% | 5.00% | 5.00% |
| 1-Octanol | 4.13% | 4.13% | 4.13% | 4.13% |
| Proxel ® GXL | 0.10% | 0.10% | 0.10% | 0.10% |
| SAG 1572 | 0.01% | 0.01% | 0.01% | 0.01% |
| DI Water | 52.83% | 61.66% | 53.24% | 62.06% |
| Total: | 100.00% | 100.00% | 100.00% | 100.00% |
| Citric Acid | 0.01% | 0.005% | 0.01% | 0.005% |

TABLE 7
Concentrate compositions with three herbicidal active ingredients

| | | C159 (wt. | | C188 (wt. |
|---|---|---|---|---|
| | C159 | % actives | C188 | % actives |
| Constituent | (wt. %) | content) | (wt. %) | content) |
| Fluazifop P-butyl | 4.13% | 4.00% | 4.13% | 4.00% |
| Triclopyr TEA | 11.25% | 5.00% | 11.25% | 5.00% |
| Diquat dibromide | 3.96% | 1.50% | 3.96% | 1.50% |
| Agnique ® CSO-25 | 15.00% | 15.00% | 23.00% | 23.00% |
| Makon ® TSP-12 | 3.35% | 3.35% | — | — |
| PEG 400 | 5.00% | 5.00% | 5.00% | 5.00% |
| 1-Octanoic acid | 3.35% | 3.35% | 4.13% | 4.13% |
| Proxel ® GXL | 0.10% | 0.10% | 0.10% | 0.10% |
| SAG 1572 | 0.01% | 0.01% | 0.01% | 0.01% |
| DI Water | 53.85% | 62.69% | 48.42% | 57.26% |
| Total: | 100.00% | 100.00% | 100.00% | 100.00% |
| pH-value | 5.83 | 5.83 | 5.84 | 5.84 |

TABLE 8
Concentrate composition with three herbicidal active ingredients

| | | C191 |
|---|---|---|
| | C191 | (wt. % actives |
| Constituent | (wt. %) | content) |
| Fluazifop P-butyl | 4.13% | 4.00% |
| Triclopyr TEA | 11.25% | 5.00% |
| Diquat dibromide | 3.96% | 1.50% |
| Agnique ® CSO-25 | 15.00% | 15.00% |
| Makon ® TSP-12 | 15.00% | 15.00% |
| PEG 400 | 5.00% | 5.00% |
| Proxel ® GXL | 0.10% | 0.10% |
| SAG 1572 | 0.01% | 0.01% |
| DI Water | 45.55% | 54.39% |
| Total: | 100.00% | 100.00% |
| pH-value | 7.23 | 7.23 |

The herbicidal composition shown in Table 8 was free of an organic solvent selected from the group of C₄-C₁₂ alkanols or C₄-C₁₂ fatty acids, i.e. did not contain 1-hexanol, 1-octanol or 1-octanoic acid. A stable formulation was achieved in this case by using a higher amount of surfactants. The flash points measured for microemulsions according to the present invention containing for example 1-hexanol or 1-octanol was higher than 100° C., whereas 1-hexanol and 1-octanol have a flash point of 65° C. and of 81° C., respectively.

### Example G: Post-Emergence Weed Control Data—Greenhouse Trials

Seeds of the respective weed plants were sown in 3.5 inches (8.89 cm) pots containing a 50:50 mix of Redi-earth (Sun Gro, Bellevue, Washington) and soil at 0.5 to 0.75 inches (1.27 to 1.905 cm) deep. The compositions of the present invention were then applied each to the different weed species post-emergence under the same conditions using a laboratory track sprayer calibrated to deliver 145 gallons per acre (about 1356.32 L/ha). For comparison, commercially available products were applied under the same conditions. Following the respective application, the pots were placed in a greenhouse and overhead irrigated with 0.25 inches (0.635 cm) for activation and maintained under good growth conditions for the weed plants. Visual scoring of the damage to the weed plants took place after a respective trial time indicated in the following Tables in comparison to untreated controls (herbicidal activity in percent (%): 100% activity=plants have died; 0% activity=as control plants). The results are set out in Table G1 below. Weed species that were evaluated were Digitaria sanguinalis (DIGSA), Lolium perenne (LOLPE), Portulaca oleracea (POROL) and Trifolium repens (TRFRE).

TABLE G1
Greenhouse trial results using different
compositions/products - control at 23 DAT
Weed control in % (23 DAT)

| Composition/Product | DIGSA | LOLPE | POROL | TRFRE |
|---|---|---|---|---|
| Spectracide RTU | 95 | 96.5 | 100 | 100 |
| Roundup L&G RTU | 100 | 100 | 100 | 80 |
| C-52 from Table 1 | 99 | 85 | 100 | 95.8 |
| C-70 from Table 3 | 99 | 93.3 | 100 | 94.5 |
| C-92 from Table 1 | 99 | 92.8 | 100 | 93.3 |
| C-95 from Table 2 | 100 | 100 | 100 | 88.8 |
| C-100 from Table 3 | 100 | 94.8 | 100 | 88.8 |
| C-102 from Table 2 | 100 | 95 | 100 | 89.5 |
| C-136 from Table 4 | 97.3 | 80 | 100 | 76.3 |
| C-159 from Table 7 | 98 | 78.8 | 100 | 83.8 |
| UTC | 0.0 | 0.0 | 0.0 | 0.0 |

### EMBODIMENTS

For further illustration, additional non-limiting embodiments of the present invention are set forth below.

Embodiment 1 is a herbicidal composition comprising herbicidal active ingredients, wherein the herbicidal active ingredients comprise or consist of
(A) fluazifop or an ester thereof, and
(B) triclopyr or an ester or an agriculturally acceptable salt thereof,
wherein the total amount of component (B) is at least about 4.5 wt. %, based on the total weight of the composition,
and/or
wherein the sum of the total amounts of Component (A) and Component (B) is at least about 8.0 wt. %, based on the total weight of the composition.

Embodiment 2 is the herbicidal composition according to Embodiment 1, wherein the herbicidal active ingredients comprise or consist of
(A) fluazifop or an ester thereof,
(B) triclopyr or an ester or an agriculturally acceptable salt thereof, and
(C) a diquat dihalide salt.

Embodiment 3 is the herbicidal composition according to Embodiment 1 or 2, wherein
Component (A) comprises or consists of a fluazifop alkyl ester, preferably a fluazifop-P-alkyl ester, and
Component (B) comprises or consists of a triclopyr ammonium salt.

Embodiment 4 is the herbicidal composition according to Embodiment 1 or 2, wherein
Component (A) comprises or consists of fluazifop-P-butyl, and
Component (B) comprises or consists of triclopyr-triethylammonium.

Embodiment 5 is the herbicidal composition according to Embodiment 2, wherein
Component (A) comprises or consists of fluazifop-P-butyl,
Component (B) comprises or consists of triclopyr-triethylammonium, and
Component (C) comprises or consists of diquat dibromide.

Embodiment 6 is the herbicidal composition according to any one of Embodiments 1 to 5, wherein the sum of the total amounts of Component (A) and Component (B) is in the range of from about 8.0 wt. % to about 12.0 wt. %, based on the total weight of the composition.

Embodiment 7 is the herbicidal composition according to any one of Embodiments 1 to 5, wherein the sum of the total amounts of Component (A) and Component (B) is in the range of from about 8.5 wt. % to about 10.0 wt. %, based on the total weight of the composition.

Embodiment 8 is the herbicidal composition according to any one of Embodiments 2 to 7, wherein the sum of the total amounts of Component (A), Component (B) and Component (C) is in the range of from about 9.0 wt. % to about 15.0 wt. %, based on the total weight of the composition.

Embodiment 9 is the herbicidal composition according to any one of Embodiments 2 to 7, wherein the sum of the total amounts of Component (A), Component (B) and Component (C) is in the range of from about 9.5 wt. % to about 13.0 wt. %, based on the total weight of the composition.

Embodiment 10 is the herbicidal composition according to any one of Embodiments 1 to 9, wherein the ratio by weight of the total amount of component (A) to the total amount of component (B) is in the range of from about 3:2 to about 2:5, based on the total weight of the composition.

Embodiment 11 is the herbicidal composition according to any one of Embodiments 1 to 9, wherein the ratio by weight of the total amount of component (A) to the total amount of component (B) is in the range of from about 1:1 to about 1:2, based on the total weight of the composition.

Embodiment 12 is the herbicidal composition according to any one of Embodiments 1 to 9, wherein the ratio by weight of the total amount of component (A) to the total amount of component (B) is in the range of from about 4:5 to about 3:5, based on the total weight of the composition.

Embodiment 13 is the herbicidal composition according to any one of Embodiments 2 to 12, wherein the ratio by weight of the total amount of component (B) to the total amount of component (C) is in the range of from about 5:1 to about 3:2, based on the total weight of the composition.

Embodiment 14 is the herbicidal composition according to any one of Embodiments 2 to 12, wherein the ratio by weight of the total amount of component (B) to the total amount of component (C) is in the range of from about 10:3 to about 5:3, based on the total weight of the composition.

Embodiment 15 is the herbicidal composition according to any one of Embodiments 1 to 14, wherein components (A), (B), and optionally (C) are the only herbicidal active ingredients present in the composition.

Embodiment 16 is the herbicidal composition according to any one of Embodiments 1 to 15, wherein the total amount of component (B) is in the range of from about 4.5 wt. % to about 6.0 wt. %, based on the total weight of the composition.

Embodiment 17 is the herbicidal composition according to any one of Embodiments 1 to 15, wherein the components (A) and (B) are present in the composition in the following amounts:
Component (A) in an amount in the range of from about 3.0 wt. % to about 4.0 wt. %, and
Component (B) in an amount in the range of from about 4.5 wt. % to about 5.5 wt. %,
in each case based on the total weight of the composition.

Embodiment 18 is the herbicidal composition according to any one of Embodiments 2 to 15, wherein the components (A), (B) and (C) are present in the composition in the following amounts:
Component (A) in an amount in the range of from about 3.0 wt. % to about 4.0 wt. %,
Component (B) in an amount in the range of from about 4.5 wt. % to about 5.5 wt. %, and
Component (C) in an amount in the range of from about 1.0 wt. % to about 3.5 wt. %,
in each case based on the total weight of the composition.

Embodiment 19 is the herbicidal composition according to any one of Embodiments 2 to 15, wherein the components (A), (B) and (C) are present in the composition in the following amounts:
Component (A) in an amount in the range of from about 3.0 wt. % to about 4.0 wt. %,
Component (B) in an amount in the range of from about 5.0 wt. %, and
Component (C) in an amount in the range of from about 1.5 wt. % to about 3.0 wt. %,
in each case based on the total weight of the composition.

Embodiment 20 is the herbicidal composition according to any one of Embodiments 1 to 19, wherein the herbicidal composition further comprises one or more non-ionic surfactants.

Embodiment 21 is the herbicidal composition according to any one of Embodiments 1 to 20, wherein the herbicidal composition further comprises one or more ethoxylated non-ionic surfactants, preferably one or more ethoxylated non-ionic surfactants with a degree of ethoxylation of at least about 2 (polyethoxylated non-ionic surfactants).

Embodiment 22 is the herbicidal composition according to any one of Embodiments 1 to 21, wherein the herbicidal composition further comprises one or more polyethoxylated non-ionic surfactants selected from the group consisting of polyethoxylated fatty acid esters, polyethoxylated fatty alcohols, tristyrylphenol polyethoxylates, polyethoxylated amines, and mixtures thereof.

Embodiment 23 is the herbicidal composition according to any one of Embodiments 1 to 22, wherein the herbicidal composition further comprises one or more polyethoxylated non-ionic surfactants selected from the group consisting of polyethoxylated castor oils.

Embodiment 24 is the herbicidal composition according to any one of Embodiments 1 to 23, wherein the herbicidal composition further comprises one or more polyethoxylated non-ionic surfactants selected from the group consisting of polyethoxylated castor oils with a degree of ethoxylation in the range of from about 10 to about 50.

Embodiment 25 is the herbicidal composition according to any one of Embodiments 1 to 24, wherein the herbicidal composition further comprises one or more polyethoxylated non-ionic surfactants selected from the group consisting of polyethoxylated castor oils with a degree of ethoxylation in the range of from about 20 to about 40.

Embodiment 26 is the herbicidal composition according to any one of Embodiments 1 to 24, wherein the herbicidal composition further comprises one or more polyethoxylated non-ionic surfactants selected from the group consisting of polyethoxylated castor oils with a degree of ethoxylation in the range of from about 25 to about 30.

Embodiment 27 is the herbicidal composition according to any one of Embodiments 1 to 26, wherein the herbicidal composition further comprises one or more polyethoxylated non-ionic surfactants selected from the group consisting of tristyrylphenol polyethoxylates.

Embodiment 28 is the herbicidal composition according to any one of Embodiments 1 to 27, wherein the herbicidal composition further comprises one or more polyethoxylated non-ionic surfactants selected from the group consisting of tristyrylphenol polyethoxylates with a degree of ethoxylation in the range of from about 10 to about 20.

Embodiment 29 is the herbicidal composition according to any one of Embodiments 1 to 28, wherein the herbicidal composition further comprises one or more polyethoxylated non-ionic surfactants selected from the group consisting of tristyrylphenol polyethoxylates with a degree of ethoxylation in the range of from about 12 to about 16.

Embodiment 30 is the herbicidal composition according to any one of Embodiments 1 to 29, wherein the herbicidal composition further comprises one or more polyethoxylated non-ionic surfactants selected from the group consisting of fatty acids polyethoxylates.

Embodiment 31 is the herbicidal composition according to any one of Embodiments 1 to 30, wherein the herbicidal composition further comprises one or more polyethoxylated non-ionic surfactants selected from the group consisting of polyethoxylated tall oil fatty acids.

Embodiment 32 is the herbicidal composition according to Embodiment 30 or 31, wherein the fatty acids polyethoxylates are selected from the group consisting of fatty acids polyethoxylates with a degree of ethoxylation in the range of from about 2 to about 10.

Embodiment 33 is the herbicidal composition according to any one of Embodiments 1 to 32, wherein the herbicidal composition further comprises one or more polyethoxylated non-ionic surfactants selected from the group consisting of cocoamine polyethoxylates.

Embodiment 34 is the herbicidal composition according to any one of Embodiments 1 to 33, wherein the herbicidal composition further comprises one or more polyethoxylated non-ionic surfactants selected from the group consisting of cocoamine polyethoxylates with a degree of ethoxylation in the range of from about 2 to about 20, preferably with a degree of ethoxylation in the range of from about 2 to about 10.

Embodiment 35 is the herbicidal composition according to any one of Embodiments 1 to 34, wherein the composition comprises one or more surfactants in a total amount in the range of from about 10 wt. % to about 30 wt. %, based on the total weight of the composition.

Embodiment 36 is the herbicidal composition according to any one of Embodiments 1 to 34, wherein the composition comprises one or more surfactants in a total amount in the range of from about 12 wt. % to about 25 wt. %, based on the total weight of the composition.

Embodiment 37 is the herbicidal composition according to any one of Embodiments 1 to 34, wherein the composition comprises one or more surfactants in a total amount in the range of from about 15 wt. % to about 22 wt. %, based on the total weight of the composition.

Embodiment 38 is the herbicidal composition according to any one of Embodiments 1 to 37, wherein the herbicidal composition additionally comprises water and one or more further constituents selected from the group consisting of ionic surfactants, other emulsifiers, dispersants, organic solvents, anti-freeze agents, pH-regulation agents, biocides and antifoam agents.

Embodiment 39 is the herbicidal composition according to any one of Embodiments 1 to 38, wherein the herbicidal composition comprises one or more organic solvents, preferably one or more organic solvents that are liquid at 25° C. and 1013 mbar.

Embodiment 40 is the herbicidal composition according to any one of Embodiments 1 to 39, wherein the herbicidal composition comprises one or more organic solvents selected from the group consisting of C₄-C₁₂ alkanols, C₄-C₁₂ alkylene glycols and C₄-C₁₂ fatty acids, and mixtures thereof.

Embodiment 41 is the herbicidal composition according to any one of Embodiments 1 to 40, wherein the herbicidal composition comprises one or more organic solvents selected from the group consisting of primary C₄-C₁₂ alkanols, C₄-C₁₂ alkane 1,2-diols and primary C₄-C₁₂ alkanoic acids, and mixtures thereof.

Embodiment 42 is the herbicidal composition according to any one of Embodiments 1 to 41, wherein the herbicidal composition comprises one or more organic solvents selected from the group consisting of primary straight chain C₆-C₁₀ alkanols, straight chain C₆-C₁₀ alkane 1,2-diols and primary straight chain C₆-C₁₀ alkanoic acids, and mixtures thereof.

Embodiment 43 is the herbicidal composition according to any one of Embodiments 1 to 42, wherein the herbicidal composition comprises one or more organic solvents selected from the group consisting of 1-hexanol, 1-octanol, 1-decanol, 1-dodecanol, 1-hexanoic acid, 1-octanoic acid, 1-decanoic acid, 1-dodecanoic acid, and mixtures thereof.

Embodiment 44 is the herbicidal composition according to any one of Embodiments 1 to 43, wherein the herbicidal composition comprises one or more organic solvents selected from the group consisting of 1-hexanol, 1-octanol, 1-octanoic acid, and mixtures thereof.

Embodiment 45 is the herbicidal composition according to any one of Embodiments 1 to 44, wherein the herbicidal composition comprises an organic solvent comprising or consisting of 1-octanol or 1-octanoic acid.

Embodiment 46 is the herbicidal composition according to any one of Embodiments 1 to 45, wherein the herbicidal composition comprises one or more organic solvents, wherein the total amount of organic solvents is in the range of from about 2 wt. % to about 20 wt. %, based on the total weight of the composition.

Embodiment 47 is the herbicidal composition according to any one of Embodiments 1 to 45, wherein the herbicidal composition comprises one or more organic solvents, wherein the total amount of organic solvents is in the range of from about 5 wt. % to about 15 wt. %, based on the total weight of the composition.

Embodiment 48 is the herbicidal composition according to any one of Embodiments 1 to 45, wherein the herbicidal composition comprises one or more organic solvents, wherein the total amount of organic solvents is in the range of from about 8 wt. % to about 12 wt. %, based on the total weight of the composition.

Embodiment 49 is the herbicidal composition according to any one of Embodiments 39 to 45, wherein the herbicidal composition comprises one or more organic solvents selected from the group consisting of C₄-C₁₂ alkanols, C₄-C₁₂ alkylene glycols and C₄-C₁₂ fatty acids, wherein the total amount of these organic solvents is in the range of from about 1 wt. % to about 10 wt. %, based on the total weight of the composition.

Embodiment 50 is the herbicidal composition according to any one of Embodiments 39 to 45, wherein the herbicidal composition comprises one or more organic solvents selected from the group consisting of C₄-C₁₂ alkanols, C₄-C₁₂ alkylene glycols and C₄-C₁₂ fatty acids, wherein the total amount of these organic solvents is in the range of from about 3 wt. % to about 8 wt. %, based on the total weight of the composition.

Embodiment 51 is the herbicidal composition according to any one of Embodiments 39 to 45, wherein the herbicidal composition comprises one or more organic solvents selected from the group consisting of C₄-C₁₂ alkanols, C₄-C₁₂ alkylene glycols and C₄-C₁₂ fatty acids, wherein the total amount of these organic solvents is in the range of from about 4 wt. % to about 6 wt. %, based on the total weight of the composition.

Embodiment 52 is the herbicidal composition according to any one of Embodiments 1 to 51, wherein the herbicidal composition comprises one or more polyethylene glycols.

Embodiment 53 is the herbicidal composition according to any one of Embodiments 1 to 51, wherein the herbicidal composition comprises one or more polyethylene glycols with a molar mass in the range of from about 250 to about 800 g/mol.

Embodiment 54 is the herbicidal composition according to any one of Embodiments 1 to 51, wherein the herbicidal composition comprises one or more polyethylene glycols with a molar mass in the range of from about 300 to about 600 g/mol.

Embodiment 55 is the herbicidal composition according to any one of Embodiments 1 to 51, wherein the herbicidal composition comprises one or more polyethylene glycols with a molar mass in the range of from about 350 to about 450 g/mol.

Embodiment 56 is the herbicidal composition according to any one of Embodiments 1 to 51, wherein the herbicidal composition comprises polyethylene glycol 400 (PEG 400).

Embodiment 57 is the herbicidal composition according to any one of Embodiments 52 to 56, wherein the total amount of said polyethylene glycols is in the range of from about 2 wt. % to about 10 wt. %, based on the total weight of the composition.

Embodiment 58 is the herbicidal composition according to any one of Embodiments 52 to 56, wherein the total amount of said polyethylene glycols is in the range of from about 3 wt. % to about 8 wt. %, based on the total weight of the composition.

Embodiment 59 is the herbicidal composition according to any one of Embodiments 52 to 56, wherein the total amount of said polyethylene glycols is in the range of from about 4 wt. % to about 6 wt. %, based on the total weight of the composition.

Embodiment 60 is the herbicidal composition according to any one of Embodiments 1 to 59, wherein the herbicidal composition comprises one or more polyethylene glycols and one or more primary C₄-C₁₂ alkanols.

Embodiment 61 is the herbicidal composition according to any one of Embodiments 1 to 59, wherein the herbicidal composition comprises one or more polyethylene glycols and one or more primary C₄-C₁₂ alkanols, wherein the total amount by weight of said polyethylene glycols and said primary C₄-C₁₂ alkanols is in the range of from 3:1 to 1:3, based on the total weight of the composition.

Embodiment 62 is the herbicidal composition according to any one of Embodiments 1 to 59, wherein the herbicidal composition comprises one or more polyethylene glycols and one or more primary C₄-C₁₂ alkanols, wherein the total amount by weight of said polyethylene glycols and said primary C₄-C₁₂ alkanols is in the range of from 2:1 to 1:2, based on the total weight of the composition.

Embodiment 63 is the herbicidal composition according to any one of Embodiments 1 to 59, wherein the herbicidal composition comprises one or more polyethylene glycols and one or more primary C₄-C₁₂ alkanols, wherein the total amount by weight of said polyethylene glycols and said primary C₄-C₁₂ alkanols is about 1:1, based on the total weight of the composition.

Embodiment 64 is the herbicidal composition according to any one of Embodiments 1 to 63, wherein water is present in the composition in a total amount in the range of from about 45 wt. % to about 80 wt. %, based on the total weight of the composition.

Embodiment 65 is the herbicidal composition according to any one of Embodiments 1 to 63, wherein water is present in the composition in a total amount in the range of from about 50 wt. % to about 75 wt. %, based on the total weight of the composition.

Embodiment 66 is the herbicidal composition according to any one of Embodiments 1 to 63, wherein water is present in the composition in a total amount in the range of from about 55 wt. % to about 70 wt. %, based on the total weight of the composition.

Embodiment 67 is the herbicidal composition according to any one of Embodiments 1 to 66, wherein the composition comprises one or more antifoam agents.

Embodiment 68 is the herbicidal composition according to any one of Embodiments 1 to 66, wherein the composition comprises one or more silicone-based antifoam agents.

Embodiment 69 is the herbicidal composition according to any one of Embodiments 1 to 66, wherein the composition comprises one or more silicone-based antifoam emulsions and/or polydimethylsiloxane-based antifoam emulsions.

Embodiment 70 is the herbicidal composition according to any one of Embodiments 1 to 69, wherein the composition comprises one or more biocides.

Embodiment 71 is the herbicidal composition according to any one of Embodiments 1 to 70, wherein the composition comprises 1,2-benzisothiazolin-3-one.

Embodiment 72 is the herbicidal composition according to any one of Embodiments 1 to 71, wherein the composition is an aqueous herbicidal liquid composition at 25° C. and 1013 mbar.

Embodiment 73 is the herbicidal composition according to any one of Embodiments 1 to 72, wherein the composition is in the form of an oil-in-water emulsion.

Embodiment 74 is the herbicidal composition according to any one of Embodiments 1 to 72, wherein the composition is in the form of a microemulsion.

Embodiment 75 is the herbicidal composition according to any one of Embodiments 1 to 72, wherein the composition is in the form of an oil-in-water microemulsion.

Embodiment 76 is the herbicidal composition according to any one of Embodiments 1 to 75, wherein the composition has a pH-value in the range of from about 5 to about 9 when measured at 25° C. and 1013 mbar.

Embodiment 77 is the herbicidal composition according to any one of Embodiments 1 to 75, wherein the composition has a pH-value in the range of from about 5.5 to about 8.5 when measured at 25° C. and 1013 mbar.

Embodiment 78 is the herbicidal composition according to any one of Embodiments 1 to 75, wherein the composition has a pH-value in the range of from about 6.5 to about 8.5 or of from about 6.8 to about 8.2 when measured at 25° C. and 1013 mbar.

Embodiment 79 is the herbicidal composition according to any one of Embodiments 1 to 75, wherein the composition has a pH-value in the range of from about 5.0 to about 7.0 or of from about 5.5 to about 6.0 when measured at 25° C. and 1013 mbar.

Embodiment 80 is the herbicidal composition according to any one of Embodiments 1 to 79, wherein the composition is free of glyphosate, esters and salts thereof, and free of dicamba, esters and salts thereof.

Embodiment 81 is a ready-to-use spray application mixture, obtainable or obtained by diluting the herbicidal composition according to any one of Embodiments 1 to 80 with water.

Embodiment 82 is a ready-to-use spray application mixture, obtainable or obtained by diluting the herbicidal composition according to any one of Embodiments 1 to 80 with water in a ratio by volume in the range of from about 1:25 to about 1:60.

Embodiment 83 is a ready-to-use spray application mixture, obtainable or obtained by diluting the herbicidal composition according to any one of Embodiments 1 to 80 with water in a ratio by volume in the range of from about 1:35 to about 1:50.

Embodiment 84 is a ready-to-use spray application mixture, obtainable or obtained by diluting the herbicidal composition according to any one of Embodiments 1 to 80 with water in a ratio by volume in the range of from about 1:40 to about 1:45.

Embodiment 85 is a method for controlling weed plants, characterized in that a composition according to any one of Embodiments 1 to 84 is applied to the unwanted plants, plant parts or to the area on which the unwanted plants are growing or will be growing.

Embodiment 86 is the use of a composition according to any one of Embodiments 1 to 84 for controlling unwanted plants.

Embodiment 87 is the method or use according to Embodiment 85 or 86, wherein the herbicidal composition according to any one of Embodiments 1 to 80 or the spray application mixture according to any one of Embodiments 81 to 84 is applied to the unwanted plants in the field of environmental health, preferably hardscapes, roadsides, driveways, patios, sidewalks, gravel areas, parks, public gardens, private gardens, plantations, orchards, sports grounds, arenas, mulch beds, in or around flower beds, in vegetable gardens, in or around landscape(d) areas, around perennial landscape plants, around trees and shrubs, plantations, orchards, along fences and foundations, edging around foundations, buildings or retaining walls, wooded or vacant lots, recreational areas, fields, trails, parks, sports facilities, xeriscapes, desert landscapes, rockgardens, around homes, buildings, cabins, lodges or camp sites, vines growing up poles, mature trees, trunks or freshly cut woody stumps.

Embodiment 88 is the method or use according to any one of Embodiments 85 to 87, characterized in that it is carried out pre-emergence, early post-emergence or post-emergence of the unwanted plants to be controlled.

Embodiment 89 is the method or use according to any one of Embodiments 85 to 88, wherein the composition is used at an application rate such that the amount of component (A) is in the range of from about 1000 g/ha to about 2000 g/ha.

Embodiment 90 is the method or use according to any one of Embodiments 85 to 88, wherein the composition is used at an application rate such that the amount of component (A) is in the range of from about 1200 g/ha to about 1500 g/ha.

Embodiment 91 is the method or use according to any one of Embodiments 85 to 88, wherein the composition is used at an application rate such that the amount of component (B) is in the range of from about 1000 g/ha to about 2500 g/ha.

Embodiment 92 is the method or use according to any one of Embodiment 85 to 88, wherein the composition is used at an application rate such that the amount of component (B) is in the range of from about 1500 g/ha to about 1800 g/ha.

Embodiment 93 is a method of manufacturing a composition according to any one of to any one of Embodiments 1 to 80, wherein Component (A) is mixed with Component (B), and optionally Component (C), and further constituents present in the composition.

Example embodiments have been provided so that this disclosure will be thorough, and will fully convey the scope to those who are skilled in the art. Numerous specific details are set forth such as examples of specific compositions, components, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

When introducing elements of the present disclosure or the preferred embodiments(s) thereof, the articles “a”, “an”, “the” and “said” are intended to mean that there are one or more of the elements. The terms “comprising”, “including” and “having” are intended to be inclusive and mean that there may be additional elements other than the listed elements. The compositions, components, method steps, processes, and operations described herein are not to be construed as necessarily requiring their performance in the particular order discussed or illustrated, unless specifically identified as an order of performance. It is also to be understood that additional or alternative components, steps, etc. may be employed.

Although the terms first, second, third, etc. may be used herein to describe various elements, components, etc., these elements, components, etc., should not be limited by these terms. These terms may be only used to distinguish one element, component, etc. from another element, component, etc. Terms such as “first,” “second,” and other numerical terms when used herein do not imply a sequence or order unless clearly indicated by the context. Thus, a first element, component, etc. discussed below could be termed a second element, component, etc. without departing from the teachings of the example embodiments.

As various changes could be made in the above compositions and methods without departing from the scope of the present disclosure, it is intended that all matter contained in the above description shall be interpreted as illustrative and not in a limiting sense.

Having described the present disclosure in detail, it will be apparent that modifications and variations are possible without departing from the scope of the present disclosure defined in the appended claims.

What is claimed is:

1. Herbicidal composition comprising herbicidal active ingredients, wherein the herbicidal active ingredients comprise or consist of
(A) fluazifop or an ester thereof,
and
(B) triclopyr or an ester or an agriculturally acceptable salt thereof,
wherein the total amount of component (B) is at least about 4.5 wt. %, based on the total weight of the composition,
and/or
wherein the sum of the total amounts of Component (A) and Component (B) is at least about 8.0 wt. %, based on the total weight of the composition.

2. The herbicidal composition according to claim 1, wherein the herbicidal active ingredients comprise or consist of
(A) fluazifop or an ester thereof,
(B) triclopyr or an ester or an agriculturally acceptable salt thereof,
and
(C) a diquat dihalide salt.

3. The herbicidal composition according to claim 1,
wherein
Component (A) comprises or consists of fluazifop-P-butyl,
and
Component (B) comprises or consists of triclopyr-triethylammonium.

4. The herbicidal composition according to claim 2, wherein
Component (A) comprises or consists of fluazifop-P-butyl,
Component (B) comprises or consists of triclopyr-triethylammonium,
and
Component (C) comprises or consists of diquat dibromide.

5. The herbicidal composition according to claim 1, wherein the sum of the total amounts of Component (A) and Component (B) is in the range of from about 8.0 wt. % to about 12.0 wt. %, based on the total weight of the composition.

6. The herbicidal composition according to claim 1, wherein the ratio by weight of the total amount of component (A) to the total amount of component (B) is in the range of from about 3:2 to about 2:5.

7. The herbicidal composition according to claim 2, wherein the ratio by weight of the total amount of component (B) to the total amount of component (C) is in the range of from about 5:1 to about 3:2.

8. The herbicidal composition according to claim 1, wherein the components (A) and (B) are present in the composition in the following amounts:
Component (A) in an amount in the range of from about 3.0 wt. % to about 4.0 wt. %,
and
Component (B) in an amount in the range of from about 4.5 wt. % to about 5.5 wt. %, in each case based on the total weight of the composition.

9. The herbicidal composition according to claim 1, wherein the components (A), (B) and (C) are present in the composition in the following amounts:
Component (A) in an amount in the range of from about 3.0 wt. % to about 4.0 wt. %,
Component (B) in an amount in the range of from about 4.5 wt. % to about 5.5 wt. %,
and
Component (C) in an amount in the range of from about 1.0 wt. % to about 3.5 wt. %, in each case based on the total weight of the composition.

10. The herbicidal composition according to claim 1, wherein components (A), (B), and optionally (C) are the only herbicidal active ingredients present in the composition.

11. The herbicidal composition according to claim 1, wherein the herbicidal composition comprises one or more non-ionic surfactants, typically one or more polyethoxylated non-ionic surfactants, preferably selected from the group consisting of polyethoxylated fatty acid esters, polyethoxylated fatty alcohols, tristyrylphenol polyethoxylates, cocoamine polyethoxylates, and mixtures thereof.

12. The herbicidal composition according to claim 1, wherein water is present in the composition in a total amount in the range of from about 45 wt. % to about 80 wt. %, based on the total weight of the composition.

13. A ready-to-use spray application mixture, obtainable or obtained by diluting the herbicidal composition according to claim 1 with water, in a ratio by volume in the range of from about 1:25 to about 1:60.

14. Method for controlling weed plants, characterized in that a composition according to claim 1 is applied to the unwanted plants, plant parts or to the area on which the unwanted plants are growing or will be growing.

15. Use of a composition according to claim 1 for controlling unwanted plants.
